(19) United States
(12) Patent Application Publication
(10) Pub. No.: US 2019/0116809 A1
(43) Pub. Date: Apr. 25, 2019

(54) ERECTING GINGERBREAD STRUCTURES USING CLIPS ASSISTING TO CONNECT ADJACENT GINGERBREAD COMPONENTS

(71) Applicant: BRAND CASTLE LLC, Bedford Heights, OH (US)

(72) Inventor: James E. Zeilinger, SHAKER HEIGHTS, OH (US)

(21) Appl. No.: 15/914,727

(22) Filed: Mar. 7, 2018

Related U.S. Application Data
(60) Provisional application No. 62/707,074, filed on Oct. 20, 2017.

(51) Int. Cl. A21D 13/47; A23G 3/34; A21D 13/24

(52) U.S. Cl. CPC A21D 13/47; A23V 2002/00; A21D 13/24; A23G 3/343

(57) ABSTRACT

Gingerbread structures are constructed from baked gingerbread components that typically include both upstanding wall components, and roof components that overlie some of the upstanding wall components. The present invention also relates 1) to substantially rigid clips installed to underlie, grip, connect and/or strengthen elongate joints formed between adjacent pairs of the gingerbread components; and 2) to gingerbread structures constructed from the baked gingerbread components and the substantially rigid clips. Construction of gingerbread structures is assisted by the use of the substantially rigid clips that also help to hold adjacent pairs of gingerbread components in desired assembled orientations while lines of icing set up to bond adjacent pairs of the gingerbread components that define elongate joints of the gingerbread structures.

### REFERENCE TO PROVISIONAL APPLICATION

This application claims the benefit of the filing date of a Provisional Application Ser. No. 62/707,074 entitled METHOD OF ERECTING GINGERBREAD STRUCTURES USING CLIPS ASSISTING TO CONNECT ADJACENT GINGERBREAD COMPONENTS filed by James E. Zeilinger on Oct. 20, 2017, Atty's Dkt. No. 7-535, the disclosure of which is incorporated herein by reference.

### CROSS-REFERENCE TO RELATED DESIGN APPLICATIONS

This application is also a continuation-in-part of three related design applications, namely:

1) Application Serial No. 29/651,014 filed Oct. 20, 2017 entitled SET OF CLIPS THAT FACILITATE THE ERECTION OF GINGERBREAD HOUSES AND BUILDINGS filed by James E. Zeilinger on Oct. 20, 2017, Atty's Dkt. No. 7-536, the disclosure of which is incorporated herein by reference;

3) Application Serial No. 29/651,013 filed Oct. 20, 2017 entitled BASE CLIP THAT FACILITATES THE ERECTION OF GINGERBREAD HOUSES AND BUILDINGS filed by James E. Zeilinger on Oct. 20, 2017, Atty's Dkt. No. 7-538, the disclosure of which is incorporated herein by reference; and 2) Application Serial No. 29/651,012 filed Oct. 20, 2017 entitled ROOF SUPPORT CLIP THAT FACILITATES THE ERECTION OF GINGERBREAD HOUSES AND BUILDINGS filed by James E. Zeilinger on Oct. 20, 2017, Atty's Dkt. No. 7-537, the disclosure of which is incorporated herein by reference.

### FIELD OF THE INVENTION

The present invention relates to the construction of gingerbread structures formed from baked gingerbread components that typically include both upstanding wall components having edge regions that cooperate to define upstanding corner joints, and roof components that overlie some of the upstanding wall components. The present invention also relates to substantially rigid clips that are configured to grip, and/or to underlie and support gingerbread components that cooperate in adjacent pairs to define elongate joints of gingerbread structures being erected. In some instances, the rigid clips serve to strengthen one or more of the elongate joints that are bonded by lines of icing that extend along nearby ones of the elongate joints. In some instances, the rigid clips help to hold pairs of adjacent gingerbread components in desired assembled orientations while lines of icing set up along elongate joints defined by the pairs of adjacent gingerbread components.

### BACKGROUND

It has long been known to construct relatively small one room house-like structures from substantially flat pieces of baked gingerbread of substantially uniform thickness that have configurations designed to form the upstanding sidewall components and overlying roof components of the house-like structures, with elongate joints that extend between adjacent pairs of the baked gingerbread components being bonded by lines of icing that extend along the elongate joints.

It has also been long known to prepare flat pieces of baked gingerbread which are of substantially uniform thickness to form wall and roof components that, when assembled with lines of icing extending along the joints between pairs of adjacent components, define structures which are more complex than simple one-room house-like structures. Many of these more complex structures typically have upstanding wall components that extend to a variety of heights, lengths or widths, with the upstanding wall components being overlaid by roof components that cooperate in a variety of ways to add interesting complexity to the resulting structures.

A long-standing problem associated with the construction of baked gingerbread structures of the type just described has been a weakness of the mere lines of icing that are used to bond, and to thereby retain adjacent gingerbread components in desired assembled orientations.

A more effective means other than the use of mere lines of icing has long been needed to connect, bond and support adjacent components of structures formed from baked gingerbread components.

### SUMMARY OF THE INVENTION

The present invention utilizes a set of relatively small, substantially rigid clips to grip and/or to underlie and support overlying edge regions of adjacent pairs of baked gingerbread components that are assembled to form a gingerbread structure, such as a rectangular house, or other form or type of gingerbread structure.

The substantially rigid clips utilized by the present invention are preferably of two types, namely 1) base clips that are configured to both underlie and grip overlying edge regions of pairs of adjacent upstanding gingerbread wall components that define upstanding corner joints of a gingerbread structure being formed, and 2) roof support clips that are configured to grip one, and to supportively underlie the other of a pair of adjacent gingerbread components that form one or more of the elongate roof joints of a gingerbread structure being formed.

Some of the clips supplement the bonding action of lines of icing that extend along the lengths of such elongate joints as are defined by pairs of adjacent gingerbread components of a gingerbread structure. Some of the clips help to retain desired assembled configurations of one or more pairs of joint-defining gingerbread components that are bonded by lines of icing that may not completely set up until after the clips have been installed.

The lines of icing that extend along and bond pairs of adjacent gingerbread components are preferably spaced from where the clips are installed, so the icing does not overlie or otherwise hide from view portions of the installed clips. As such, the inedible clips are kept from being confused with the edible lines of icing.

If the clips are formed from substantially rigid hard candy such as that used in making candy canes and the like, all of the clips, the icing, and the baked gingerbread components of structures formed in accordance with the present invention are edible—which means that the need to distinguish the clips from the icing is not deemed as important as when the clips are inedible.

In one form of preferred practice, a pair of adjacent gingerbread components that cooperate to form at least one of the elongate joints of a gingerbread structure has a line of icing that extends along the joint—AND, the bonding action of the line of icing is supplemented by a rigid clip that grips both gingerbread components OF THE VERY SAME JOINT that has its gingerbread components bonded by a line of icing.

In another form of preferred practice, a pair of adjacent gingerbread components that are bonded by a line of icing extending therealong, has the bonding action of the line of icing strengthened by a rigid clip installed on the adjacent gingerbread components OF A NEARBY JOINT of a gingerbread structure—with the rigid clip gripping one, and simply supportively underlying the other of the pair of adjacent gingerbread components that define the nearby joint of the gingerbread structure.

### BRIEF DESCRIPTION OF THE DRAWINGS

FIG. 1 is a perspective view showing a basic set of six relatively stiff clips that are preferably used in constructing a gingerbread structure of the type shown in FIG. 20;

FIG. 2 is a top, front and left side perspective view of one of the four identical base clips that are preferably included in the basic set of clips shown in FIG. 1;

FIG. 3 is a front view thereof;

FIG. 4 is a rear view thereof;

FIG. 5 is a top view thereof;

FIG. 6 is a bottom view thereof;

FIG. 7 is a left side view thereof, it being understood that a right side view thereof is a mirror image hereof;

FIG. 8 is a top, front and left side perspective view of one of the two identical roof support clips that are preferably included in the basic set of clips shown in FIG. 1;

FIG. 9 is a front view thereof;

FIG. 10 is a rear view thereof;

FIG. 11 is a top view thereof;

FIG. 12 is a bottom view thereof;

FIG. 13 is a left side view thereof, it being understood that a right side view thereof is a mirror image hereof;

FIG. 14 is an elevational view, on a smaller scale, showing the configuration of a basic set of six baked gingerbread components of substantially uniform thickness that preferably are used in constructing the gingerbread structure shown in FIG. 20, with the component set including identical first and second five-sided end wall components, identical first and second rectangular sidewall components, and identical first and second rectangular roof components;

FIG. 15 is a schematic view showing (by means of a curved arrow) how the first end wall component is moved to an assembled position where opposite end regions of a bottom edge thereof has been inserted into aligned, upwardly opening channels defined by a first pair of the four base clips, with each of the four base clips being depicted in a location where one of four corner regions of the house-like structure shown in FIG. 20 eventually will be located;

FIG. 16 is a perspective view showing a bottom edge of the first end wall component inserted into aligned, upwardly opening channels of the first pair of the base clips, with the view also showing new lines of icing applied to opposite upstanding end regions of an interior surface of the first upstanding end wall component at locations where the first and second sidewall components will be moved to assembled positions to bond with the first upstanding end wall component, it being noted that in FIGS. 16-20 broken lead lines point to hidden channels 27 and 28 of the base clips 20;

FIG. 17 is a perspective view showing the interior surface of the first upstanding end wall component at a time after the two upstanding sidewall components have bottom edge portions inserted into aligned, upwardly opening channels of a second pair of the depicted base clips, with new lines of icing applied to two upstanding edges of the first and second sidewall components so the new lines of icing will be engaged by opposite end regions of the interior surface of the second upstanding end wall component when the second end wall component is moved to its assembled position shown in FIG. 18;

FIG. 18 is a perspective view showing a more completely assembled version of the structure of FIG. 20 at a time after the second upstanding five-sided end wall component has been moved to its assembled position where opposite end regions of the bottom edge of the second upstanding end wall component are inserted into aligned channels of the second pair of base clips, with the assembled position also causing the second upstanding end wall component to become bonded to the first and second upstanding sidewall components by the new lines of icing that have been applied to the upstanding edges of the two sidewall components, as shown in FIG. 17;

FIG. 19 is a perspective view showing two new lines of icing that have been applied to parallel-extending, inclined upper edges of the first and second end wall components, with the view also showing how one of the two roof support clips has been installed to grip an uppermost edge region of a first one of the upstanding sidewall components, with a support arm of the roof support clip extending outwardly away from an exterior surface of the gripped sidewall component for underlying a lower edge region of a first of the rectangular roof components when moved to its assembled position shown in FIG. 20; and

FIG. 20 is a perspective view showing the completed structure after the first and second gingerbread roof components have been moved to their assembled positions atop lines of icing that have been applied to all of the inclined upper edges of the first and second end wall components, and after a second roof support clip (not shown) has been installed to grip the upper edge region of the second sidewall component in the manner that the first roof support clip was installed to grip the first sidewall component (as shown in FIG. 19) to supportively underlie the lower edge of the second roof component, with FIG. 20 showing an upper edge region of one of the roof components being broken away so that an optional line of icing can be seen added to a trough defined by upper edges of the first and second roof components.

### DETAILED DESCRIPTION

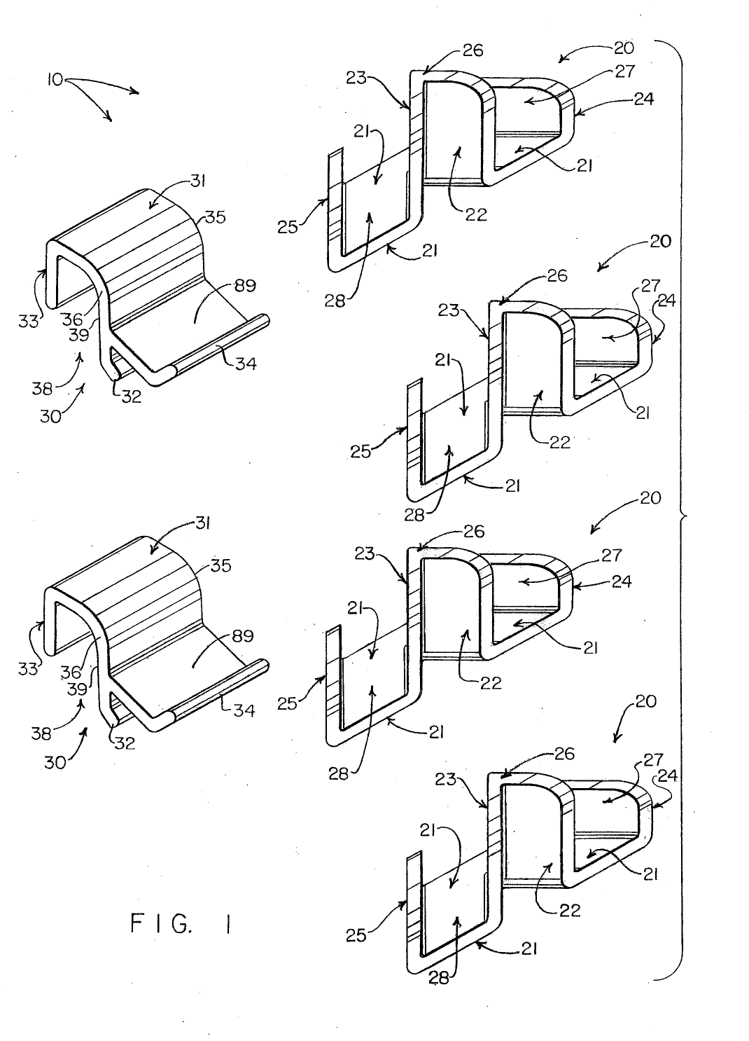

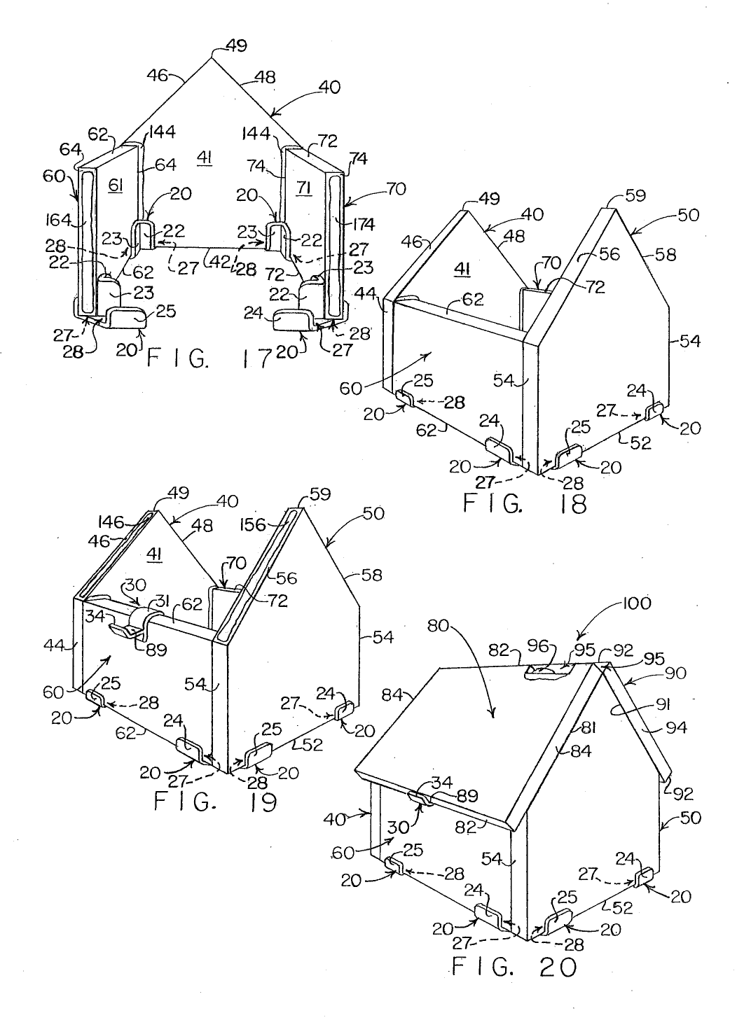

Referring to FIG. 1, a set of six substantially rigid clips, indicated generally by the numeral 10, embodies one aspect of the present invention. Still another aspect of the present invention relates to gingerbread structures that are formed using substantially rigid clips of the general type that are included in the set of clips indicated by the numeral 10. Yet another aspect of the present invention includes such methods of construction as are used to form the house-like gingerbread structure 100 shown in FIG. 20—it being noted that the steps of construction of one such method are illustrated by the sequence of views provided by FIGS. 15-20.

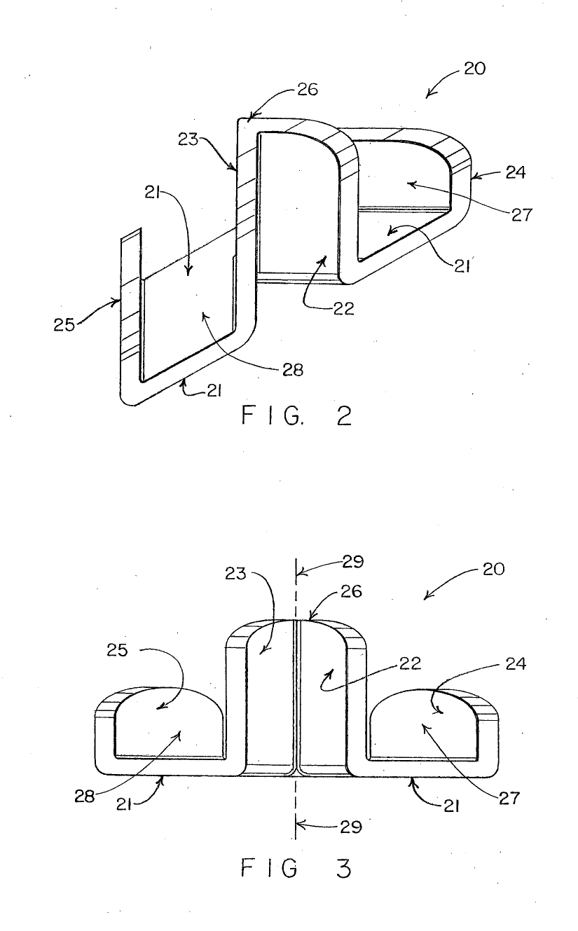

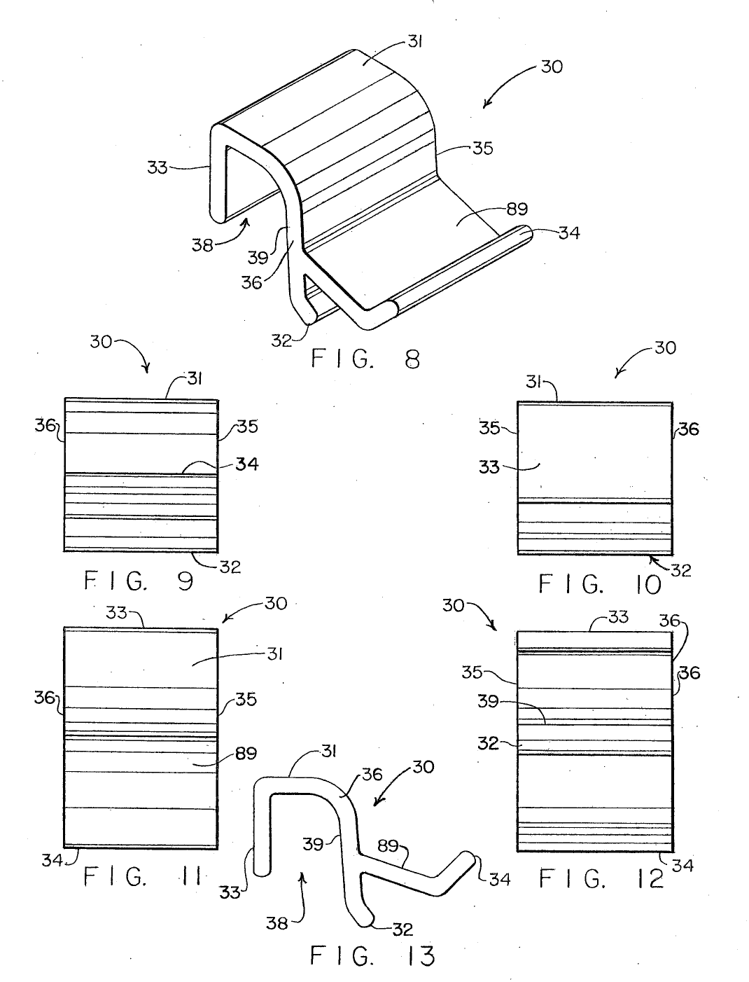

Referring to FIG. 1, the set of substantially rigid clips 10 includes four identical base clips 20 (that also are shown in FIGS. 2-7), and two identical roof support clips 30 (that also are shown in FIGS. 8-13).

As this detailed description progresses, it will become apparent that, in several ways, not only the base clips 20, but also the completed gingerbread structure 100 exhibit a significant degree of symmetry, as will now be explained.

Insofar as the completed gingerbread structure 100 (shown in FIG. 20) is concerned, the structure 100 has “dual symmetry” in that left and right halves of the structure 100 are symmetrical (in that the left and right halves are mirror images of each other), and the front and rear halves of the structure 100 also are symmetrical (in that they, too, are mirror images of each other).

This “dual symmetry” of the structure 100 means that, as the construction of the structure 100 progresses, what takes place during the assembly of a first end region of the structure 100 (where the first end wall component 40 is located), will also take place during the assembly of the second end region of the structure 100 (where the second end wall component 50 is located); and, likewise, what takes place during the assembly of a left side of the structure 100 (where the first sidewall component 60 is located), will also take place during the assembly of the right side of the structure 100 (where the second sidewall component 70 is located).

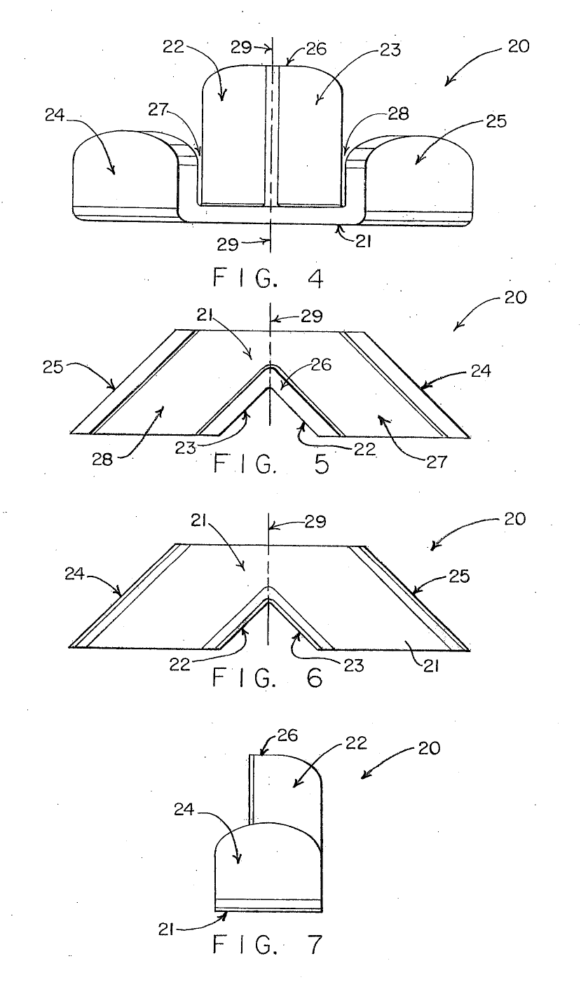

Insofar as the symmetry of the base clips 20 (shown in FIGS. 1-7) is concerned, each of the base clips 20 has right and left sides that are symmetrical about a centerline 29 that can be seen in the front view of FIG. 3, the rear view of FIG. 4, the top view of FIG. 5, and the bottom view of FIG. 6.

Referring to the top view provided by FIG. 5, it can be seen that each of the identical base clips 20 has a pair of upwardly opening, oppositely inclined, channels 27, 28—with the right channel 27 being a mirror image of the left channel 28. The channels 27, 28 are of generally U-shaped cross-section, with the upwardly opening U-shaped channel 27 having its opposite sides defined by a pair of upwardly extending, uniformly spaced, wall elements 22 and 24; and, with the upwardly opening U-shaped channel 28 having its opposite sides defined by a pair of upwardly extending, uniformly spaced, wall elements 23 and 25.

Unlike the symmetry exhibited by each of the base clips 20, the roof support clips 30 exhibit no symmetry whatsoever. Referring to FIGS. 1, 8 and 13, each of the roof support clips 30 has right a right side 35 and a left side 36, as well as a topmost surface 31, a bottom-most surface 32, a rearmost wall 33, and a frontmost surface 34.

As can best be seen in FIGS. 1, 8 and 13, a downwardly opening U-shaped channel 38 is defined between the rearmost wall 33 and a complexly curved central wall 39 of each of the roof support clips 30. Each of the roof support clips 30 also has a forwardly-extending, upwardly-turned support arm 89 that reaches from the curved wall 39 to the forwardmost surface 34.

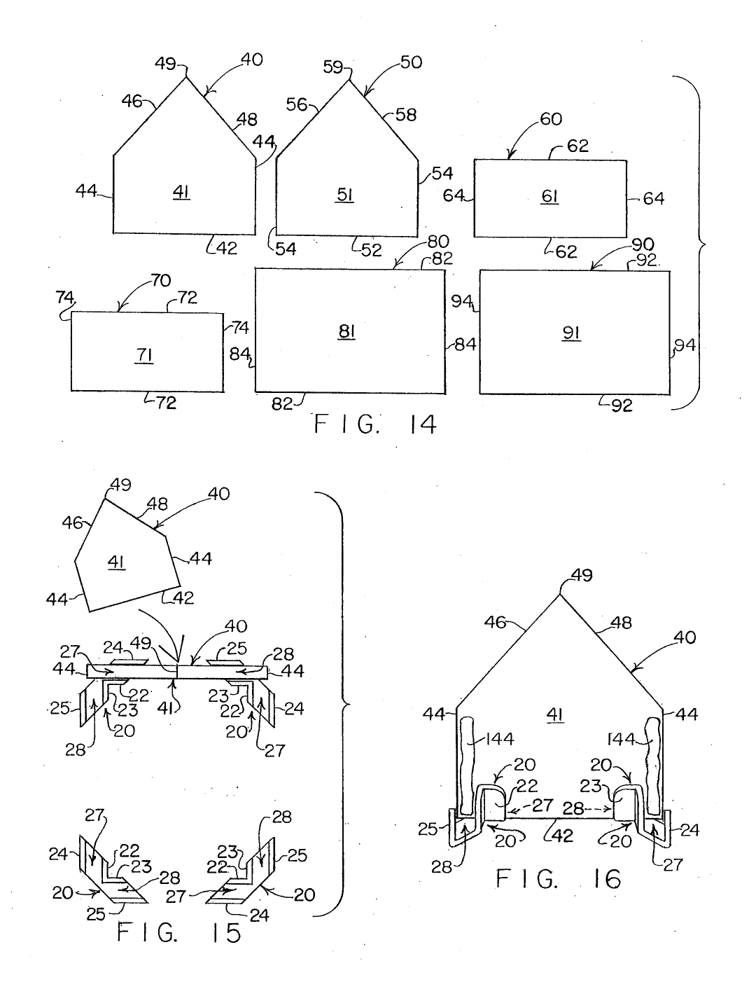

A common dimensional characteristic shared by the base clips 20 and the roof support clips resides in a uniform width of the upwardly opening U-shaped channels 27, 28 of the base clips 20, and of the downwardly opening U-shaped channels 38 of the roof support clips 30. This common dimensional width of the U-shaped channels 27, 28 and 38 is selected to render each of the U-shaped channels 27, 28 and 38 capable of receiving and securely gripping any of the edge regions of the preferably uniformly thick baked gingerbread components that are shown in FIG. 14.

Shown in FIG. 14 is a set of six baked gingerbread components that are indicated by the numerals 40, 50, 60, 70, 80 and 90. The components 40, 50, 60, 70, 80 and 90 comprise a set of substantially flat, substantially equally thick, baked gingerbread components of the type that preferably are used in the construction of such gingerbread structures as the house-like structure 100 shown in FIG. 20.

The baked gingerbread components 40, 50, 60, 70, 80 and 90 have what will be referred to as “interior surfaces” that are indicated in FIG. 14 by the numerals 41, 51, 61, 71, 81 and 91, respectively. As this detailed description of the construction of the structure 100 progresses, it will become clear that the gingerbread components 40, 50, 60, 70, 80 and 90 are moved to assembled positions that cause the interior surfaces 41, 51, 61, 71, 81 and 91, respectively, to face toward the interior of the structure 100.

Referring again to FIG. 14, the identical pair of gingerbread components 40 and 50 are five-sided first and second upstanding end wall components that help to define the identical first and second end regions of the completed structure 100. The identical pair of gingerbread components 60 and 70 are rectangular first and second sidewall components that extend between and connect the first and second end wall components 40 and 50, respectively, of the structure 100. The identical pair of gingerbread components are 80 and 90 are rectangular first and second roof components that cooperate to overlie the upstanding components 40, 50, 60 and 70 to form a gable roof of the structure 100.

The first and second end wall components 40, 50 have bottom edges 42, 52, respectively, as well as opposed upstanding edges 44, 54, respectively, and oppositely inclined, upper edges 46,48 and 56,58, respectively, that lead to peak points 49 and 59, respectively.

The first and second sidewall components 60, 70 have opposed bottom and top edges 62, 72, respectively, and opposite upstanding side edges 64, 74, respectively.

The first and second roof components 80, 90 have opposed bottom and top edges 82, 92, respectively, and opposite upstanding side edges 84, 94, respectively.

Having described the base clips 20, the roof support clips 30 as well as the baked gingerbread components 40, 50, 60, 70, 80 and 90, reference is now made to FIGS. 15-20 which depict, somewhat schematically, the steps of a method by which the structure 100 shown in FIG. 20 can be assembled or constructed.

As is shown in the lower two-thirds of FIG. 15, construction of the structure 100 is preferably begun by arranging the four identical base clips 20 (of the clip set 10 shown in FIG. 1) in a rectangular array, with each of the base clips 20 being positioned where a different one of the four corners of the completed structure 100 will eventually reside. The uppermost pair of the base clips 20 (in the rectangular array shown in in FIG. 15) will be referred to as a first pair of the base clips 20; and, the lowermost pair of the base clips 20 will be referred to as a second pair of the base clips 20.

A curved arrow is provided in FIG. 15 to indicate how the first upstanding end wall component 40 (shown in an upper portion of FIG. 15) is moved to an assembled position (shown in the lower portion of FIG. 15), by causing opposite end regions of the bottom edge 42 of the first upstanding end wall component 40 to be inserted into two aligned, upwardly opening channels 27, 28 of the first pair of the four base clips 20.

Because many of the upwardly opening channels 27 and 28 of the base clips 20 that are shown in FIGS. 16-20 are hidden from view, broken lead lines (comprised of a series of dash marks) have been used in FIGS. 16-20 to point to where these hidden channels 27 and 28 are located.

A next step of constructing the structure 100 is shown in FIG. 16 where it can be seen that parallel-extending lines of icing 144 have been applied to opposite upstanding end regions of the interior surface 41 of the first end wall component 40 at locations where the lines of icing 144 will be engaged by upstanding edges 64, 74 of the first and second sidewall components 60, 70, respectively, when the first and second sidewall components 60, 70 are moved to their assembled positions shown in FIG. 17.

A next assembly step is shown in FIG. 17 where it can be seen that the upstanding edges 64, 74 of the first and second sidewall components 60, 70, respectively, have been inserted into the two remaining, upwardly-opening channels 27 and 28 of the same pair of the base clips into which opposite upstanding edges 44 of the first end wall component 40 have already been inserted (as is shown in FIGS. 15 and 16).

As the upstanding edges 64, 74 of the sidewall components 60, 70, respectively, engage and are pressed against the lines of icing 144, the first and second sidewall components 60, 70 become bonded to the first upstanding end wall component 40.

In FIG. 17, new lines of icing 164 and 174 are also shown that have been applied to upstanding edges 64 and 74 of the first and second sidewall components 60 and 70, respectively. When the second end wall component 50 is moved into its assembled position (shown in FIG. 18) to thereby be added to the structure 100 that is being formed, the lines of icing 164, 174 are engaged by opposite end regions of the interior surface 51 of the second end wall component 50, which causes the second end wall component 50 to become bonded to the first and second sidewall components 60, 70, just as the lines of icing 144 applied to opposite end regions of the interior surface 41 of the first end wall component 40 have caused the first and second sidewall components 60, 70 to become bonded to the first end wall component 40.

FIG. 18 shows that, when the second upstanding end wall component 50 is moved to its assembled position, opposite end regions of the bottom edge 52 of the second upstanding end wall component 40 have been inserted into aligned channels 27, 28 of the second pair of base clips 20, in the same manner that opposite end regions of the bottom edge 42 of the first upstanding end wall component 50 have been inserted into aligned channels 27, 28 of the first pair of base clips 20.

FIG. 19 shows the partially assembled structure 100 with one of the two identical roof support clips 30 installed so as to grip the upper edge region of the first sidewall component 60, and with the support arm 89 of the installed first roof support clip 30 positioned so the support arm 89 will underlie and support the lower region of the first roof component 80 when the first roof component 80 is moved to its assembled position (shown in FIG. 20) with the lower edge region of the first roof component 80 overlying the upper edge 62 of the first sidewall component 60.

It will be understood that, just as one of the two roof support clips 30 is installed to grip the upper edge region of the first sidewall component 60, the other of the two roof support clips 30 (not shown in FIG. 19) is installed in the same manner to grip the upper edge region of the second sidewall component 70, so the support arm 89 of the second roof support clip 30 is ready to underlie and support the lower edge region of the second roof component 90 when the second roof component 90 is moved to its assembled position with its lower edge region overlying the upper edge 72 of the second sidewall component 70.

In FIG. 19, new lines of icing 146, 156 are shown to have been applied to the inclined upper edges 46, 56 of the first and second end wall components, respectively, to engage and bond with opposite end regions of the interior surface 81 of the first roof component 80 when the first roof component 80 is positioned so the opposite end regions of its interior surface 81 overlie the inclined upper edges 46, 56 of the first and second end wall components 40, 50, respectively.

Finally, in FIG. 20, the completed structure 100 is shown with the first and second roof components 80, 90 moved into their assembled positions where the regions of their lower edges 82, 92 are underlaid and supported by the support arms 89 of the first and second roof support clips 30 that grip upper edge regions of the first and second sidewall components 60, 70, respectively.

As can also be seen in FIG. 20, the uppermost edges 82, 92 of the installed first and second roof components 80, 90, respectively, have corners that cooperatively engage to form a trough 95 that extends along the full lengths of the uppermost edges 82, 92 of the first and second roof components 80, 90, respectively. A small upper region of the roof components 80, 90 is broken away in FIG. 20 to show that icing 96 can be added to the trough 95 to extend along all, or only, a part of the length of the trough 95.

### About the Clips 20, 30 and the Set of Clips 10:

In one preferred embodiment, all of the substantially rigid clips 20, 30 are formed from plastic material—typically a thermoplastic material.

In an alternate preferred embodiment, the substantially rigid clips 20, 30 are formed using edible material such as hard candy—for example, such normally hard and relatively stiff and brittle candy as is often used to form peppermint candy sticks, candy canes, and the like.

Although the set of clips 10 shown in FIG. 1 includes six clips (as has been explained), those who are skilled in the art will readily understand that gingerbread structures that are within the scope and spirit of the present invention can be formed using sets of clips (not shown) that have fewer than six clips because these structures 1) may utilize a larger or smaller number than four upstanding sidewall and end wall components (and may, therefore, need to utilize a different number of base clips to underlie and grip a lesser or greater number of corner regions), with the base clips being configured to match the mating angles required by the overlapping edges of the upstanding wall components; and/or 2) may utilize a larger or smaller number of roof components (and may, therefore, need to utilize a different number of joints wherein the roof components overlie selected ones of the upstanding wall components).

Also, as those skilled in the art will readily appreciate, if gingerbread structures being constructed have longer roof joints (wherein the roof components of these structures overlie significantly longer upstanding sidewall components than are depicted in the accompanying drawings), it may be appropriate to use more than one of the roof support clips 30 at spaced locations along these lengthy roof joints to support the lower edge regions of the roof components—which will not cause the resulting structures to depart from the spirit and scope of the present invention.

If roof inclination angles of a gingerbread structure being constructed differ from that of the structure 100 shown in FIG. 20, the support arms 89 of the roof support clips 30 will, in most instances, adequately underlie and support the lower edge regions of the overlying roof components. However, the configuration of the support arms 89 of the roof support clips 30 can be modified, as may be needed, to work with such roof inclination angles as may be used by a gingerbread structure being constructed. Such modifications will not cause the roof support clips 30 or the resulting gingerbread structures to deviate from the spirit and scope of the present invention.

### About the Lines of Icing

In preferred practice, such icing as is applied to the structure 100 is preferably kept away from the clips 20, 30—so that no icing, and no lines of icing are caused to overlie or otherwise obscure from view any of the clips 20, 30. Making certain that no icing overlies any of the clips 20, 30 can be of importance, as a safety precaution, when the clips 20, 30 are formed from plastic materials that are, of course, inedible—so that the non-edible clips 20, 30 are not confused with nearby reaches of the edible icing.

However, if the clips 20, 30 are formed from edible material—such as, for example, hard candy of the type that is used to form candy canes and the like—permitting icing, or lines of icing, to overlie portions or all of the candy-formed clips 20, 30, may be deemed to be acceptable, but is not preferred.

If desired, a line of icing 96 (a portion of which is shown in FIG. 20 where a portion of the roof of the structure 100 is broken away) can be applied to substantially fill the trough 95 that is cooperatively defined by the upper edges 82, 92 of the roof components 80, 90, respectively. Alternatively, small pieces of gingerbread (not shown) can be used to fill the trough 95, to completely hide the existence of the trough 95.

If short reaches of icing, or a line of icing 96 is applied to substantially fill the trough 95, such a line of icing will be exposed to view, which is inconsistent with all of the other lines of icing (such as are indicated by the numerals 144, 146, 156, 164 and 174) that are applied during assembly of the structure 100 so as to not show visibly to any significant degree when the structure 100 is completed.

### About the Baked Gingerbread Components 40-90:

Although the six baked gingerbread components 40-90 shown in FIG. 14 preferably have a substantially uniform thickness of about ⅜ inch to about 7/16 inch, other uniform thicknesses of baked gingerbread can be used, as a particular application may require, without departing from the spirit and scope of the present invention.

Although the baked gingerbread components that are disclosed herein preferably have a uniform thickness, gingerbread components that are not all of the same thickness can be utilized, in the event that clips such as those indicated by the numerals 20, 30 are provided that are capable of gripping the gingerbread components 40, 50, 60, 70, 80 and 90, wherever there is a need for the clips 20, 30 to do so. For example, the upstanding end wall components 40, 50 can be of one uniform thickness, while the upstanding sidewall components 60, 70, can be of a different uniform thickness, and the overlying roof components 80, 90, can be of still another uniform thickness.

Still other minor modifications to the configuration of the clips and to the configuration of the gingerbread components described herein will undoubtedly occur to those who are skilled in the art—and such minor modifications will not cause the clips, the gingerbread components, and/or the resulting gingerbread constructions to reside outside the spirit and scope of the present invention.

### About the Joints of Resulting Structures:

The structure 100 shown in FIG. 20 has many elongate joints formed between overlapping edge regions of various ones of the components 40, 50, 60, 70, 80, 90. Some of these elongate joints have lines of icing applied therealong to bond the adjacent components that form the elongate joints—and, some of these elongate joints do not have lines of icing applied therealong.

Here are some of the many observations that can be made regarding the elongate joints of the structure that are defined by pairs of adjacent gingerbread components such as are depicted in FIG. 14:

1) Some of the elongate joints of the structure 100 are underlaid, supported and/or connected ONLY BY CLIPS. These include the elongate roof joints that occur where the lower edge regions of the roof components 80 and 90 overlie the upper edges 62, 72 of the sidewall components 60, 70, respectively. No lines of icing extend along and bond the adjacent gingerbread components of either of these elongate joints.

2) Some of the elongate joints are connected ONLY BY LINES OF ICING. These include the four elongate roof joints defined where opposed upstanding edge regions of the roof components 80, 90, respectively, overlie the inclined upper edges 46, 48 and 56, 58 of the first and second end wall components 40, 50, respectively. No clips underlie or grip any of the gingerbread components 40, 50, 80 and 90 that form these elongate joints.

3) Some of the elongate icing-bonded joints are strengthened by clips installed on THE SAME JOINTS. These elongate joints include the four upstanding corner joints of the structure 100 which have the opposed, upstanding edges 44, 54 of the end wall components 40, 50, respectively, overlying the opposed upstanding edges 64, 74 of the sidewall components 60, 70, respectively. These four corner joints are underlaid by the base clips 10 that also grip the adjacent components 40,50 and 60,70 that define the four upstanding corner joints of the structure 100.

4) Some of the elongate icing-bonded joints are strengthened by clips applied ONLY TO NEARBY JOINTS. These include the four elongate roof joints where opposed edge regions of the roof components 80, 90, respectively, overlie the inclined upper edges 46,48 and 56,58 of the end wall components 40, 50, respectively.

5) Among the elongate joints of the structure 100 that DO HAVE lines of icing extending therealong are the four upstanding corner joints of the structure 100; AND the four elongate roof joints where opposed edges 84, 94 of the roof components 80, 90, respectively, overlie the inclined upper edges 46,48 and 56,58 of the first and second end wall components 40 and 50, respectively.

6) Among the elongate joints of the structure 100 that DO NOT HAVE lines of icing extending therealong are the two elongate roof joints where lower edge regions of the roof components 80 and 90 overlie the upper edges 62, 72 of the sidewall components 60, 70, respectively.

7) Among the elongate icing-bonded joints of the structure 100 that ARE ALSO CONNECTED BY CLIPS are the four upstanding corner joints of the structure 100. One of the base clips 10 underlies each of these four upstanding icing-bonded corner joints.

8) Among the elongate icing-bonded joints of the structure 100 that ARE NOT ALSO CONNECTED BY CLIPS are the four elongate roof joints that are defined by the opposed upwardly extending edge regions of the roof components 80 and 90 that overlie the inclined upper edges 46,48 and 56,58 of the end wall components 40, 50, respectively.

9) Among the elongate icing-bonded joints of the structure 100 that can be said to be strengthened by clips that are connected ONLY TO NEARBY ONES OF THE ELONGATE JOINTS, are the four elongate roof joints that are defined by opposed edge regions of the roof components 80 and 90 that overlie the inclined upper edges 46,48 and 56,58 of the end wall components 40, 50, respectively. These four elongate icing-bonded joints can be said to be at least partially strengthened by the roof support clips 30 that grip the upper edges 62, 72 of the sidewall components 60, 70, respectively, and have support arms 89 that underlie and support the lower edges 82, 92 of the roof components 80, 90, respectively.

Although the present invention has been described in a preferred form with particularity, it is understood that the present disclosure of the preferred form has been made only by way of example, and that numerous changes in the details of construction and the combination and arrangement of the clips and gingerbread components may be resorted to without departing from the spirit and scope of the invention.

What is claimed is:

1. A set of substantially rigid clips with each clip configured to grip at least one of a pair of adjacent gingerbread components that define an elongate joint of a gingerbread structure being constructed, with each clip also being configured to at least supportively underlie the other one of the pair of adjacent gingerbread components to assist in holding the adjacent pair of gingerbread components in desired assembled positions while at least one line of icing extending along at least one other of the elongate joints of the gingerbread structure being constructed sets up to bond adjacent gingerbread components that define said other of the elongate joints of the structure.

2. The set of substantially rigid clips of claim 1 wherein the set includes a plurality of base clips that are configured to underlie and grip a pair of adjacent gingerbread components that define an upstanding corner joint of the gingerbread structure being constructed.

3. The set of substantially rigid clips of claim 2 wherein each of the base clips is configured to define a pair of upwardly opening channels that are each capable of underlying and gripping one of the two gingerbread components that define the corner joint underlain by the clip.

4. The set of substantially rigid clips of claim 1 wherein the set includes at least one roof support clip that is configured to grip an upper edge region of one of a pair of adjacent gingerbread components that cooperate to define an elongate roof joint of the gingerbread structure being constructed, and to underlie and support an edge region of the other of the pair of the gingerbread components that cooperate to define the elongate roof joint.

5. The set of substantially rigid clips of claim 4 wherein the roof support clip is configured to define a downwardly opening channel that overlies and grips an upper edge region of said one of a pair of adjacent gingerbread components, and has a support arm that is configured to underlie and support an edge region of the other of the pair of gingerbread components that cooperate to define the elongate roof joint of the gingerbread structure being constructed

6. The set of substantially rigid clips of claim 1 wherein at least one of the clips of the set is formed from plastic material.

7. The set of substantially rigid clips of claim 1 wherein at least one of the clips of the set is formed from edible material.

8. A gingerbread structure formed from baked gingerbread components, with at least some of the gingerbread components cooperating in adjacent pairs to define elongate joints of the structure that have lines of icing extending therealong that bond the adjacent pairs of gingerbread components to each other, with at least a chosen one of the elongate joints defined by a particular adjacent pair of gingerbread components having a clip installed so as to grip an edge region of one of the components of the particular adjacent pair of gingerbread components, and to underlie and support the other of the gingerbread components of the particular adjacent pair.

9. The gingerbread structure of claim 8 wherein the clip is installed so as to grip edge regions of both of the components of the particular adjacent pair.

10. A method of constructing a structure formed by edible baked gingerbread components, comprising the steps of:
a) arranging at least some of the gingerbread components in adjacent pairs that cooperate to define elongate joints of the structure being constructed;
b) providing lines of icing that extend along certain of the elongate joints to bond the adjacent gingerbread components forming the certain elongate joints; and
c) installing substantially rigid clips on adjacent pairs of the gingerbread components that cooperate to form chosen ones of the elongate joints to grip at least one of the gingerbread components of the chosen elongate joints, and to at least underlie and support the other of the gingerbread components of the chosen elongate joints.

11. The method of claim 10 wherein at least one of the clips is configured to grip said other of the components of the chosen joints to strengthen at least one of the elongate joints of the structure that has a line of icing extending therealong.

12. A gingerbread structure formed from substantially flat gingerbread components of substantially uniform thickness, with some pairs of the gingerbread components extending adjacent to each other to thereby define certain elongate joints of the gingerbread structure, with some of the certain elongate joints each having a line of icing extending therealong that bonds the gingerbread components that define the certain elongate joints, and with chosen ones of the elongate joints having substantially rigid clips installed thereon that grip at least one of the gingerbread components that define the chosen ones of the elongate joints of the structure.

13. The gingerbread structure of claim 12 wherein at least one of the substantially rigid clips grips both of the gingerbread components that define an associated one of the elongate joints to hold at least one of the pairs of gingerbread components in a desired assembled orientation while a line of icing extending along the at least one of the certain elongate joints sets up.

14. A gingerbread structure formed from baked gingerbread components of substantially uniform thickness including a plurality of upstanding gingerbread wall components, and at least one overlying gingerbread roof component, with the structure having both a) plurality of elongate corner joints defined by overlying edge regions of adjacent pairs of the upstanding wall components, and b) at least one elongate roof joint defined by an edge region of the at least one gingerbread roof component overlying an upper edge region of at least one of the upstanding gingerbread wall components, with the roof component cooperating with selected ones of the wall components to define a plurality of elongate joints, with selected ones of the elongate joints each having an associated line of icing extending therealong that bonds the adjacent gingerbread components thereof to each other, with at least a chosen one of the elongate joints having a substantially rigid clip underlying and gripping one of the adjacent gingerbread components of the chosen joint, and with the substantially rigid clip also underlying and at least supporting the other of the adjacent components of the at least one chosen elongate joint.

15. The gingerbread structure of claim 14 wherein the clip also grips said other of the adjacent gingerbread components of the at least one chosen joint.

16. The gingerbread structure of claim 15 wherein said at least one chosen joint IS one of the joints that has a line of icing extending therealong.

17. The gingerbread structure of claim 15 wherein said at least one chosen joint IS NOT one of the joints that has a line of icing extending therealong.

18. The gingerbread structure of claim 14 wherein the at least one overlying roof component includes two roof components that cooperate to define a gable roof having a peak formed by the two roof components

19. The gingerbread structure of claim 14 wherein the clip is formed from substantially rigid plastic material.

20. The gingerbread structure of claim 14 wherein the clip is formed from substantially rigid edible material.

21. A method of constructing a gingerbread structure from baked gingerbread components of substantially uniform thickness, including four upstanding gingerbread wall components and at least one gingerbread roof component that overlies an upper edge region of at least one of the upstanding gingerbread wall components, with the method comprising the steps of:
a) positioning the upstanding wall components to form elongate upstanding corner joints of the structure that are each defined by a separate adjacent pair of the upstanding wall components;
b) positioning the roof component to overlie an upper edge region of at least one of the four upstanding wall components to define an elongate roof joint;
c) bonding the pairs of components that form certain of the elongate corner joints by providing lines of icing that extend therealong in contact with the adjacent gingerbread components that define each of the certain elongate corner joints; and
d) strengthening at least a selected one of the icing-bonded joints by providing a substantially rigid clip that grips at least one of the gingerbread components that defines at least a chosen one of the elongate joints, and that underlies at least the other of the gingerbread components of the chosen joint.

22. A gingerbread structure formed by four upstanding gingerbread wall components that cooperate in adjacent pairs to define elongate corner joints, and at least one roof component that adjacently overlies at least one of the wall components to define an elongate roof joint, with lines of icing extending along selected ones of the elongate joints to bond the adjacent gingerbread components that define the selected elongate joints, with four identical, substantially rigid base clips underlying the adjacent components that define each of the elongate corner joints, and with at least one substantially rigid roof support clip gripping an upper edge region of one of the upstanding wall components that forms an elongate roof joint, and underlies the a lowermost edge of the roof component that forms the elongate roof joint.
